(19) United States
(12) Patent Application Publication
(10) Pub. No.: US 2012/0000284 A1
(43) Pub. Date: Jan. 5, 2012

(54) HUMIDITY SENSOR PACKAGE AND MANUFACTURING METHOD THEREOF

(76) Inventors: Shinya Yokoyama, Niigata-ken (JP); Satoshi Waga, Niigata-ken (JP); Atsushi Tondokoro, Niigata-ken (JP); Tadashi Sakashita, Niigata-ken (JP); Hideki Hasegawa, Niigata-ken (JP); Sumihito Morita, Niigata-ken (JP); Hideki Kamimura, Niigata-ken (JP); Masaya Yamatani, Niigata-ken (JP)

(21) Appl. No.: 13/169,918

(22) Filed: Jun. 27, 2011

(30) Foreign Application Priority Data
Jul. 5, 2010 (JP) 2010-153106

(51) Int. Cl. G01N 27/22; B23P 25/00

(52) U.S. Cl. 73/335.04; 29/527.1

(57) ABSTRACT

A humidity sensor package includes: a humidity sensor that is mounted on a main surface of a package substrate and that have a humidity-sensing area; a control IC that is mounted on the main surface of the package substrate; a sealing resin that seals at least an external connection portion of the humidity sensor; and a partition member that partitions a sealing area of the sealing resin and the humidity-sensing area from each other so as to expose the humidity-sensing area to an external environment. Here, a first distance in the thickness direction from the package substrate to the top surface of the partition member is smaller than a second distance in the thickness direction from the package substrate to the top surface of the sealing resin.

### CLAIM OF PRIORITY

This application claims benefit of Japanese Patent Application No. 2010-153106 filed on Jul. 5, 2010, which is hereby incorporated by reference in its entirety.

### BACKGROUND

1. Field of the Disclosure

The present disclosure relates to a humidity sensor package and a manufacturing method thereof.

2. Description of the Related Art

A capacitive humidity sensor having as a dielectric a humidity-sensitive polymer film of which the dielectric constant varies depending on an amount of moisture absorbed or emitted is generally used as a humidity sensor used to measure a humidity variation. The capacitive humidity sensor includes a sensor unit having the humidity-sensitive polymer film and a pair of electrodes covered with the humidity-sensitive polymer film to detect the static capacitance thereof. Pad portions disposed at the ends of the pair of electrodes can be electrically connected to an external circuit by wire bonding. In such a capacitive humidity sensor, since it is necessary to expose the humidity-sensitive polymer film of the sensor unit to the atmosphere, at least a wire bonding portion as an external connection portion has to be sealed with a sealing resin.

An example of such an electronic component package which is partially sealed with a sealing member is disclosed in the pamphlet of PCT Publication No. 01/40784. In this configuration, a sensor area that is not sealed is protected with a cap member. Accordingly, the cap member and a substrate mounted with the sensor are covered with the sealing resin.

However, in the configuration disclosed in the pamphlet of PCT Publication No. 01/40784, since the sensor area is covered with the cap member, there is a problem in that the reactivity of the sensor is slow. In the configuration disclosed in the pamphlet of PCT Publication No. 01/40784, since it is necessary to individually seal sensor packages by the use of a potting method or the like at the time of sealing with the sealing resin, there is also a problem in that the mass production is poor.

### SUMMARY

A humidity sensor package includes: a humidity sensor that is mounted on a main surface of a package substrate and that has a humidity-sensing area; a control IC that is mounted on the main surface of the package substrate; a sealing resin that seals at least an external connection portion of the humidity sensor; and a partition member that partitions a sealing area of the sealing resin and the humidity-sensing area from each other so as to expose the humidity-sensing area to an external environment. Here, a first distance in the thickness direction from the package substrate to the top surface of the partition member is smaller than a second distance in the thickness direction from the package substrate to the top surface of the sealing resin.

According to this configuration, it is possible to expose the humidity-sensing area at a position close to the external environment in the state where the external connection portion such as wires for wire bonding is covered with the sealing resin. Accordingly, it is possible to improve the reactivity of the sensor without broadening the humidity-sensing area.

There is provided a method of manufacturing a humidity sensor package that includes: a mounting step of mounting a humidity sensor having a humidity-sensing area on a main surface of a package substrate; a partition forming step of forming a partition member that partitions a sealing area of the sealing resin and the humidity-sensing area from each other; a sealing step of sealing at least an external connection portion of the humidity sensor with a sealing resin; and a processing step of processing the sealing resin so that a first distance in the thickness direction from the package substrate to the top surface of the partition member is smaller than a second distance in the thickness direction from the package substrate to the top surface of the sealing resin.

According to this method, it is possible to efficiently provide a humidity sensor package including a sensor with improved reactivity without broadening the humidity-sensing area.

In the method of manufacturing a humidity sensor package, the partition member partitioning the sealing area of the sealing resin and the humidity-sensing area from each other may be formed so as to expose the humidity-sensing area to an external environment in the partition forming step. At least the external connection portion of the humidity sensor may be sealed with the sealing resin in the sealing step.

### BRIEF DESCRIPTION OF THE DRAWINGS

FIG. 1A is a perspective view illustrating a humidity sensor package according to an embodiment of the invention and FIG. 1B is an oblique perspective view thereof.

FIG. 2A is a plan view illustrating the humidity sensor package according to the embodiment of the invention and FIG. 2B is a perspective side view thereof.

FIGS. 3A to 3C are diagrams illustrating a method of manufacturing the humidity sensor package according to the embodiment of the invention.

FIG. 4 is a diagram illustrating the relation between humidity and time.

FIG. 5 is a diagram illustrating the relation between intensity and time.

FIG. 6 is a diagram illustrating the reaction time of the humidity sensor package.

FIGS. 7A to 7G are diagrams illustrating another example of the method of manufacturing the humidity sensor package according to the embodiment of the invention.

### DESCRIPTION OF THE EXEMPLARY EMBODIMENTS

Hereinafter, embodiments of the invention will be described in detail with reference to the accompanying drawings.

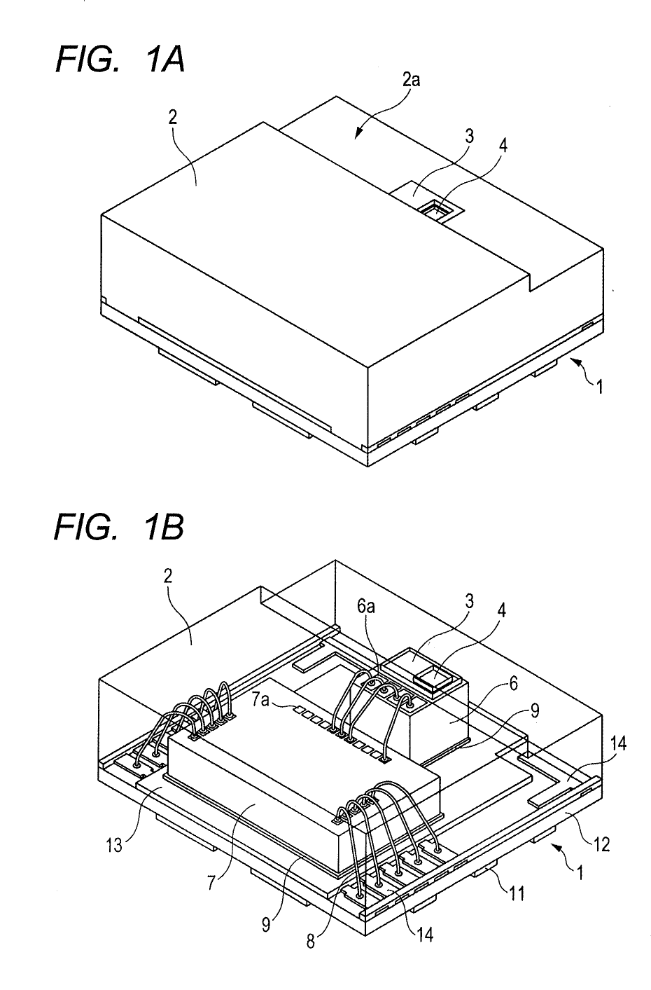

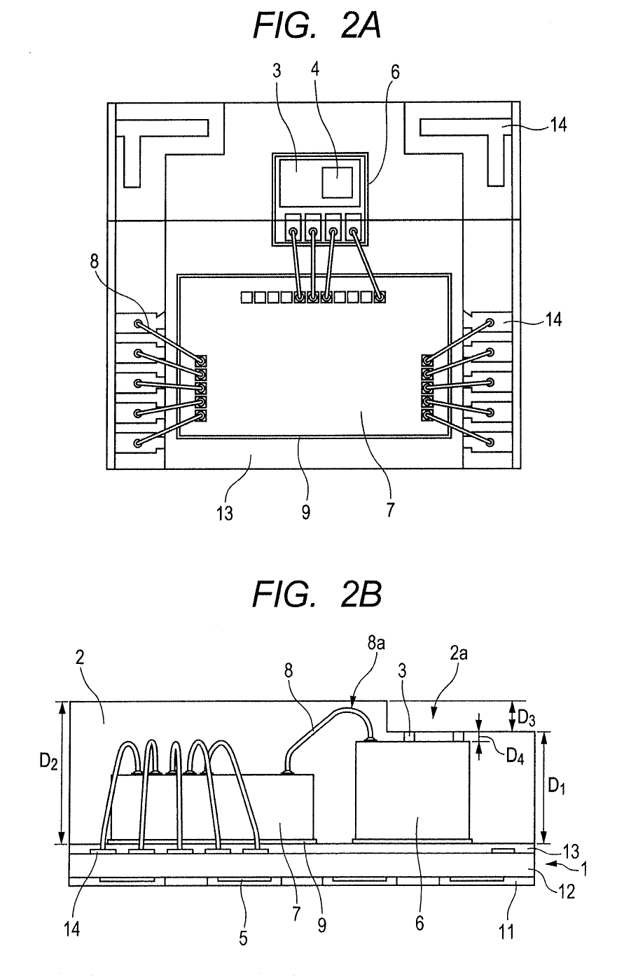

FIG. 1A is a perspective view illustrating a humidity sensor package according to an embodiment of the invention and FIG. 1B is an oblique perspective view thereof. FIG. 2A is a plan view illustrating the humidity sensor package according to the embodiment of the invention and FIG. 2B is a perspective side view thereof.

In the humidity sensor package, as shown in FIG. 1A, a humidity sensor 6 as an electronic component is mounted on a main surface of a package substrate 1 and the humidity sensor 6 is sealed with a sealing resin 2. The humidity sensor 6 has a humidity-sensing area so as to detect the humidity and the humidity-sensing area needs to be exposed to an external environment. Accordingly, at the time of sealing the humidity sensor 6 with the sealing resin 2, a partition member 3 partitioning a sealing area of the sealing resin 2 and a humidity-sensing area from each other is disposed in advance so as to expose the humidity-sensing area of the humidity sensor 6 to the external environment. That is, in the humidity sensor package, by disposing the partition member 3 partitioning the sealing area of the sealing resin 2 and the humidity-sensing area from each other in advance and sealing the humidity sensor 6 with the sealing resin 2, the humidity sensor 6 can be sealed in a state (a state where a humidity sensing hole 4 is disposed) where the humidity-sensing area of the humidity sensor 6 is exposed to the external environment.

In the humidity sensor package, as shown in FIG. 1B, the partition member 3 is disposed on the humidity sensor 6. Specifically, the partition member 3 is bonded to the humidity sensor 6 by the use of a photosensitive adhesive (not shown in the drawing).

An area for exposing electrode pads 14 is disposed on an insulating layer (an insulating layer on a sensor mounting surface) 13 of the package substrate 1. By electrically connecting the electrode pads 14 to electrode pads 7a of a control IC 7, the package substrate 1 can be electrically connected to the control IC 7. The electrode pads 14 of the package substrate 1 and the electrode pads 7a of the control IC 7 and/or electrode pads 6a of the humidity sensor 6 and the electrode pads 7a of the control IC 7 are electrically connected to each other by the use of wires 8 as the external connection portion (by wire bonding). In this case, the humidity sensor 6 and the control IC 7 are mounted on the package substrate 1.

The humidity sensor 6 of the humidity sensor package is a humidity-sensitive polymer film having a humidity-sensitive polymer material of which the dielectric constant varies depending on the amount of moisture absorbed or emitted as a dielectric. The humidity sensor 6 is die-bonded onto the package substrate 1 with a die bonding member 9 interposed therebetween. As shown in FIGS. 2A and 2B, the control IC 7 controlling sensor elements of the humidity sensor 6 is die-bonded onto the package substrate 1 with the die bonding member 9 interposed therebetween.

A glass epoxy substrate or the like can be used as the package substrate 1. As shown in FIG. 1B, the package substrate 1 includes a core member 12 and insulating layers 11 and 13 formed on both main surfaces of the core member 12. An example of the material of the insulating layers 11 and 13 is an insulating resist. As shown in FIG. 2B, a conductive layer is formed on both surfaces of the core member 12 and electrode pads 14 or electrode portions 5 are formed by patterning the conductive layer. By electrically connecting the electrode portions 5 to electrode portions of another circuit board, the humidity sensor package can be mounted on another circuit board.

The sealing resin 2 seals at least the external connection portion of the humidity sensor 6. An epoxy resin containing SiO₂ pillars can be used as the sealing resin 2. The sealing with the sealing resin 2 can be performed, for example, by transfer molding. An example of the material of the partition member 3 is silicon. The humidity sensing hole 4 formed in the partition member 3 is not particularly limited in shape, as long as it can expose the humidity-sensing area to the external environment.

In the humidity sensor package according to the embodiment of the invention, a stepped portion 2a is formed in the sealing resin 2 in an area including at least the partition member 3. The stepped portion 2a is formed so that the distance D₁ in the thickness direction from the package substrate 1 to the top surface of the partition member 3 is smaller than the distance D₂ in the thickness direction from the package substrate 1 to the top surface of the sealing resin 2. In this case, the distance D₂ is the thickness of the sealing resin 2 in the part covering the external connection portion (the wires 8), particularly, the highest portion (the portion most apart from the package substrate 1 in the thickness direction) 8a of the wires 8.

The stepped portion 2a can be formed, for example, by a dicing process. In this case, the dicing process is performed using a dicing saw with a width corresponding to the width of the stepped portion 2a. The depth D₃ of the stepped portion 2a can be properly set depending on a desired distance between the humidity-sensing area and the external environment and is preferably in the range of about 150 μm to about 200 μm. The stepped portion 2a is preferably formed so that the thickness D₄ of the partition member 3 is in the range of about 20 μm to about 50 μm in consideration of the desired distance between the humidity-sensing area and the external environment.

By forming this stepped portion, it is possible to expose the humidity-sensing area at a position close to the external environment in the state where the external connection portion such as the wires 8 of the wire bonding with the sealing resin. Accordingly, it is possible to improve the reactivity of the sensor without broadening the humidity-sensing area.

In this embodiment, the humidity sensor 6 is a capacitive humidity sensor. The capacitive humidity sensor has a sensor element mounted on a base thereof and includes a sensing section of which the static capacitance Cs varies depending on the humidity and a reference section of which the static capacitance Cr is maintained constant without depending on the humidity. The sensing section and the reference section have a parallel plate structure including a lower electrode film, a humidity-sensitive polymer film, and an upper electrode film. The lower electrode film, the humidity-sensitive polymer film, and the upper electrode film are sequentially stacked on a base from the lower electrode film, and have substantially the same circular shape in a plan view. The lower electrode film and the upper electrode film are formed of an electrode material such as Al and the thicknesses thereof are uniform. The humidity-sensitive polymer film is formed of polyimide or the like and has a uniform thickness. The gap d between the lower electrode film and the upper electrode film is the same as the thickness of the humidity-sensitive polymer film, and the static capacitance C between the lower electrode film and the upper electrode film is determined by the dielectric constant ∈ of the humidity-sensitive polymer film, the gap d between the lower electrode film and the upper electrode film, and the opposed area S(C=∈S/d).

In the reference section, a moisture-impermeable protective film blocking the transfer of moisture to and from the atmosphere is formed on the upper electrode film. The overall upper electrode film is covered with the moisture-impermeable protective film. The moisture-impermeable protective film is formed of, for example, a silicon nitride film (SiNx film) or a stacked film of Al₂O₃/SiO₂. The humidity-sensitive polymer film is covered with the upper electrode film and the moisture-impermeable protective film and is not thus exposed to the atmosphere. Accordingly, even when the humidity (the amount of moisture) in the atmosphere varies, the amount of moisture in the humidity-sensitive polymer film does not vary and thus the dielectric constant ∈ does not vary. As a result, a constant static capacitance (reference capacitance) Cr is maintained between the lower electrode film and the upper electrode film.

In the sensing section, the upper electrode film is partially covered with the moisture-impermeable protective film. Since the humidity-sensitive polymer film is exposed to the atmosphere via a part not covered with the moisture-impermeable protective film, the amount of moisture absorbed or emitted varies depending on the humidity (the amount of moisture) in the atmosphere and thus the dielectric constant ∈ varies. As a result, the static capacitance Cs between the lower electrode film and the upper electrode film varies.

The control IC 7 is electrically connected to the sensor element of the sensing section and the sensor element of the reference section, converts the difference Cs−Cr between the static capacitance Cs acquired from the sensing section and the static capacitance Cr acquired from the reference section into a voltage, and outputs the voltage.

The partition member 3 is disposed on the base of the humidity sensor 6. The partition member 3 has the humidity sensing hole 4 and the sensor element of the sensing section is exposed to the external environment via the humidity sensing hole 4. That is, the partition member 3 covers the sensor element of the reference section and exposes the sensor element (the humidity-sensing area) of the sensing section. Accordingly, it is possible to expose the sensor element (the humidity-sensing area) of the sensing section and to seal the other area. As a result, it is possible to prevent corrosion of the wires 8 or damage due to impact thereon. By disposing the partition member 3, it is possible to pick up the voltage corresponding to the difference in static capacitance as described above.

In a method of manufacturing the humidity sensor package according to the embodiment of the invention, a humidity sensor having a humidity-sensing area is mounted on a main surface of a package substrate, a partition member partitioning a sealing area of the sealing resin and the humidity-sensing area from each other is formed, at least an external connection portion of the humidity sensor is sealed with a sealing resin, and the sealing resin is processed so that a first distance in the thickness direction from the package substrate to the top surface of the partition member is smaller than a second distance in the thickness direction from the package substrate to the top surface of the sealing resin. According to this method, it is possible to efficiently provide a humidity sensor package including a sensor with improved reactivity without broadening the humidity-sensing area.

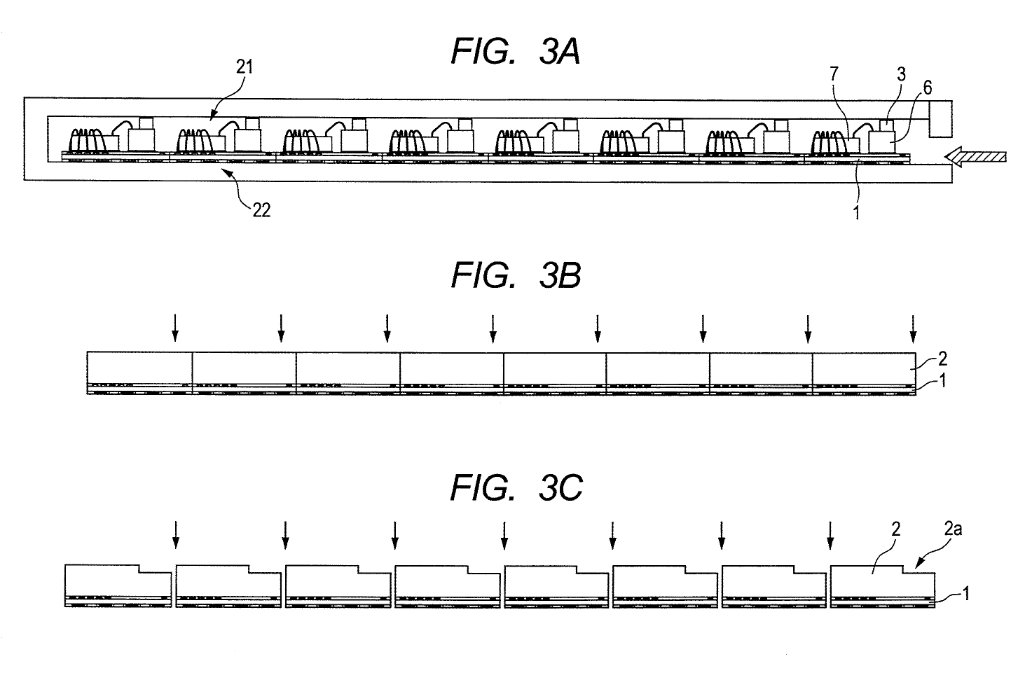

FIGS. 3A to 3C are diagrams illustrating the method of manufacturing the humidity sensor package according to the embodiment of the invention. In this method, the partition member partitioning the sealing area of the sealing resin and the humidity-sensing area from each other is formed so as to expose the humidity-sensing area to the external environment in the partition forming step, at least the external connection portion of the humidity sensor is sealed with the sealing resin in the sealing step, and the sealing resin is processed so that a first distance in the thickness direction from the package substrate to the top surface of the partition member is smaller than a second distance in the thickness direction from the package substrate to the top surface of the sealing resin.

By die-bonding the humidity sensor 6 and the control IC 7 onto the package substrate 1, wire-bonding the electrode pads of the package substrate 1 to the electrode pads of the control IC 7, and wire-bonding the electrode pads of the humidity sensor 6 to the electrode pads of the control IC 7, the humidity sensor 6 and the control IC 7 are mounted on the package substrate 1. Subsequently, the partition member 3 having the humidity-sensing hole 4 is formed on the humidity sensor 6.

Then, as shown in FIG. 3A, a device wafer in which plural sets each including the humidity sensor 6 and the control IC 7 having the partition member 3 are mounted on the package substrate 1 is set between an upper mold 21 and a lower mold 22 and a sealing resin is injected between the upper mold 21 and the lower mold 22. In this case, at least the external connection portion (the wires) of the humidity sensor 6 is sealed with the sealing resin 2.

As shown in FIG. 3B, the sealing resin 2 is processed to form the stepped portion 2a. At this time, the distance in the thickness direction from the package substrate 1 to the top surface of the partition member is set to be smaller than the distance from the package substrate 1 to the top surface of the sealing resin. Subsequently, as shown in FIG. 3C, the device wafer is diced along dicing lines to divide the wafer into individual humidity sensor packages.

An example which clarifies the advantages of the invention will be described below.

A humidity sensor (example) shown in FIGS. 1A, 1B, 2A, and 2B was manufactured using the above-mentioned method by forming a base made of silicon and forming a partition member made of silicon. At this time, the size of the package was set to 2.2 mm×2.5 mm, the thickness was set to 1.0 mm, and the depth D₃ of the stepped portion 2a shown in FIG. 2B was set to 150 μm. For the purpose of reference, a humidity sensor package (reference) not having a stepped portion was manufactured with the same size of the package as the example by forming a base made of silicon and forming a partition member out of silicon.

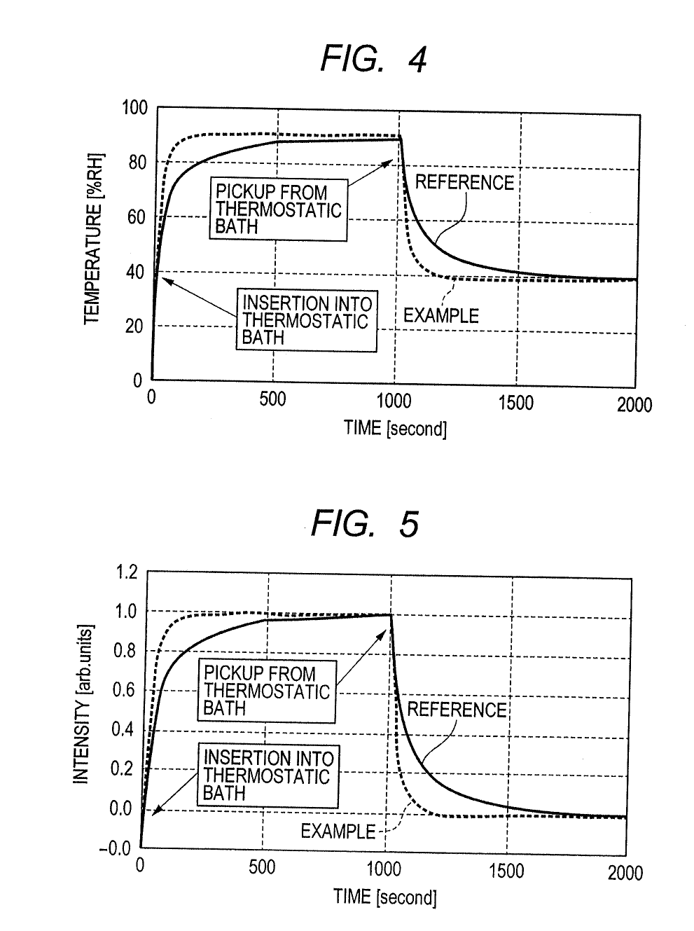

The humidity sensor packages according to the example and the reference manufactured in this way were set into a thermostatic bath and were taken therefrom to cause the humidity variation. The humidity outputs at this time are shown in FIG. 4. The intensity variations (the output is normalized with respect to the time) at this time are shown in FIG. 5. In FIG. 5, a rising reaction speed (up) is calculated with respect to the time where the intensity rises from 0 to 0.9 and a falling reaction speed (down) is calculated with respect to the time when the intensity falls from 1.0 to 0.1. The rising reaction speeds and the falling reaction speeds are shown in FIG. 6.

As can be seen from FIG. 6, the reaction speed in the humidity sensor package according to the example (having the stepped portion) is higher than the reaction speed in the humidity sensor package according to the reference (not having the stepped portion). This is because the humidity-sensing area of the humidity sensor is exposed at the position close to the external environment.

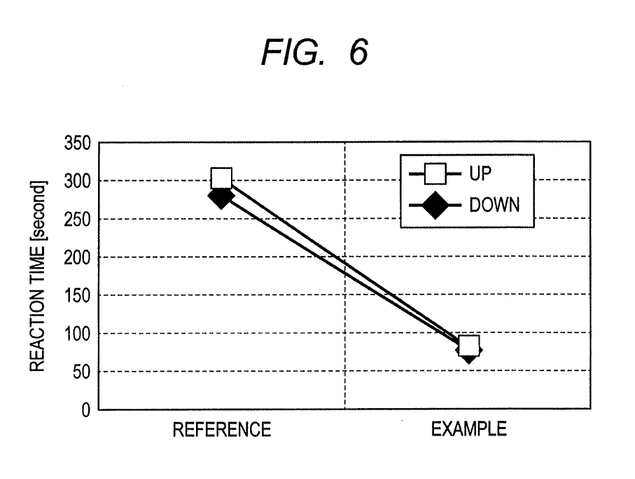

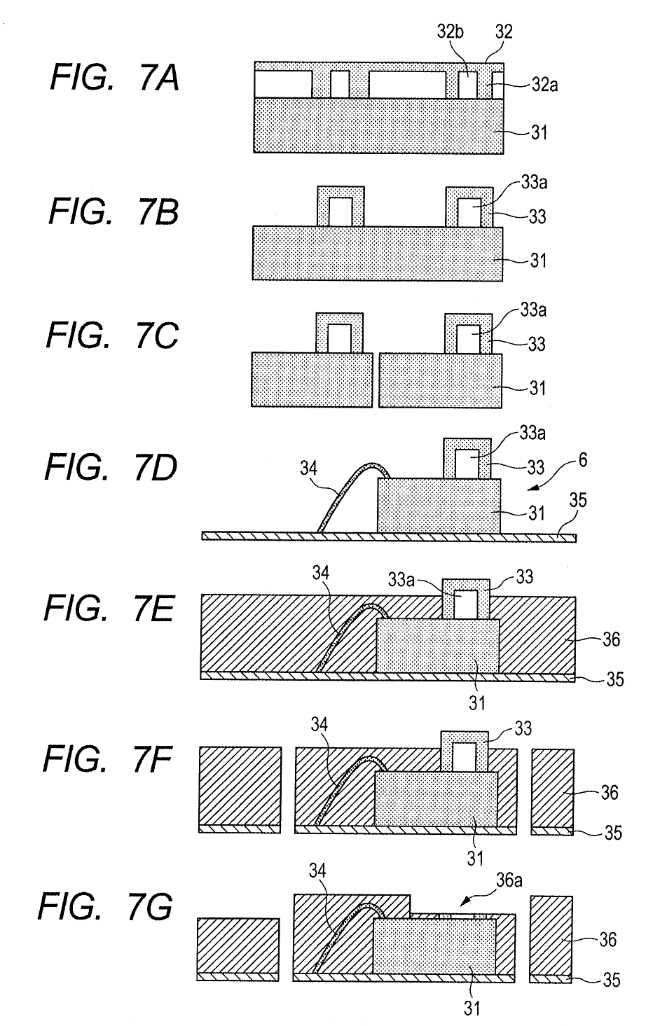

FIGS. 7A to 7G are diagrams illustrating another example of the method of manufacturing the humidity sensor package according to the embodiment of the invention. In this method, the partition member partitioning the sealing area of the sealing resin and the humidity-sensing area from each other is formed so as to cover the humidity-sensing area in the partition forming step, at least the external connection portion of the humidity sensor is sealed with the sealing resin in the sealing step, the sealing resin is processed in the processing step so that the first distance in the thickness direction from the package substrate to the top surface of the partition member is smaller than the second distance in the thickness direction from the package substrate to the top surface of the sealing resin, and the humidity-sensing area is exposed.

First, as shown in FIG. 7A, a portion 32a corresponding to the partition member and an opening 32b corresponding to the humidity sensing hole are formed on a substrate 32 becoming a cap by the use of photolithograph and etching (for example, deep RIE), and the surface of the substrate 32 on which the opening 32b is exposed is bonded to another substrate 31 (a substrate including a humidity-sensing area). Accordingly, the substrate 32 is bonded to another substrate 31 with an adhesive layer. Then, as shown in FIG. 7B, the substrate 32 is etched to form a convex portion 33 having a hollow portion 33a serving as the humidity sensing hole. Subsequently, as shown in FIG. 7C, the substrate 31 is fully diced to obtain chips. Accordingly, it is possible to achieve the humidity sensors.

As shown in FIG. 7D, by die-bonding the humidity sensor and the control IC (not shown) onto the package substrate 35, wire-bonding the electrode pads of the package substrate 35 to the electrode pads of the control IC, and wire-bonding the electrode pads of the humidity sensor 6 to the electrode pads of the control IC by the use of wires 34, the humidity sensor 6 and the control IC are mounted on the package substrate 35.

As shown in FIG. 7E, a device wafer, in which plural sets each having the humidity sensor 6 and the control IC 7 along with the convex portion 33 are mounted on the package substrate 35, is sealed with a sealing resin 36. In this case, at least the external connection portions (the wires) of the humidity sensors 6 are sealed with the sealing resin 36. At this time, the convex portions 33 are sealed to project from the upper surface of sealing resin 36.

As shown in FIG. 7F, by dicing the device wafer along dicing lines, the wafer is divided into individual humidity sensor packages. Then, as shown in FIG. 7G, the sealing resin 36 is processed to form a stepped portion 36a, and the convex portion 33 is processed to expose the humidity-sensing area. At this time, the distance in the thickness direction from the package substrate 35 to the top surface of the partition member is set to be smaller than the distance in the thickness direction from the package substrate 35 to the top surface of the sealing resin.

According to this method, since the convex portion is not opened until forming the stepped portion (the cap is not opened in the wafer processes), that is, the processes before forming the stepped portion are performed without exposing the humidity-sensing area to the external environment, it is possible to prevent the contamination of the humidity-sensing area.

The invention is not limited to the above-mentioned embodiment, but may be modified in various forms. The materials, the arranged positions, thicknesses, sizes, and formation methods of the layers, and the like in the above-mentioned embodiment can be appropriately modified. In addition, the invention can be appropriately modified without departing from the scope of the invention.

It should be understood by those skilled in the art that various modifications, combinations, sub-combinations and alterations may occur depending on design requirements and other factors insofar as they are within the scope of the appended claims of the equivalents thereof.

What is claimed is:

1. A humidity sensor package comprising:
a humidity sensor that is mounted on a main surface of a package substrate and that has a humidity-sensing area;
a control IC that is mounted on the main surface of the package substrate;
a sealing resin that seals at least an external connection portion of the humidity sensor; and
a partition member that partitions a sealing area of the sealing resin and the humidity-sensing area from each other so as to expose the humidity-sensing area to an external environment,
wherein a first distance in a thickness direction from the package substrate to the top surface of the partition member is smaller than a second distance in the thickness direction from the package substrate to the top surface of the sealing resin.

2. The humidity sensor package according to claim 1, wherein the second distance is equal to the thickness of the sealing resin in a part covering the external connection portion.

3. The humidity sensor package according to claim 1, wherein the thickness of the partition member is in the range of about 20 μm to about 50 μm.

4. A method of manufacturing a humidity sensor package, comprising:
a mounting step of mounting a humidity sensor having a humidity-sensing area on a main surface of a package substrate;
a partition forming step of forming a partition member that partitions a sealing area of the sealing resin and the humidity-sensing area from each other;
a sealing step of sealing at least an external connection portion of the humidity sensor with a sealing resin; and
a processing step of processing the sealing resin so that a first distance in a thickness direction from the package substrate to the top surface of the partition member is smaller than a second distance in the thickness direction from the package substrate to the top surface of the sealing resin.

5. The method according to claim 4, wherein the partition member partitioning the sealing area of the sealing resin and the humidity-sensing area from each other is formed so as to expose the humidity-sensing area to an external environment in the partition forming step, and
wherein at least the external connection portion of the humidity sensor is sealed with the sealing resin in the sealing step.

6. The method according to claim 4, wherein the partition member partitioning the sealing area of the sealing resin and the humidity-sensing area from each other is formed so as to cover the humidity-sensing area in the partition forming step,
wherein at least the external connection portion of the humidity sensor is sealed with the sealing resin in the sealing step, and
wherein the sealing resin is processed in the processing step so that the first distance in the thickness direction from the package substrate to the top surface of the partition member is smaller than the second distance in the thickness direction from the package substrate to the top surface of the sealing resin and the humidity-sensing area is exposed.

7. The method according to claim 4, further comprising a dicing step of dividing the humidity sensor package into individual humidity sensors by dicing the humidity sensor package along dicing lines.
